(19) United States
(12) Patent Application Publication
(10) Pub. No.: US 2020/0323234 A1
(43) Pub. Date: Oct. 15, 2020

(54) OIL OR FAT COMPOSITION FOR LAURIC CHOCOLATES, AND CHOCOLATE CONTAINING SAME

(71) Applicant: FUJI OIL HOLDINGS INC., Osaka (JP)

(72) Inventors: Shimpei WATANABE, Kaizuka-shi, Osaka (JP); Nanako KANDA, Kaizuka-shi, Osaka (JP)

(73) Assignee: FUJI OIL HOLDINGS INC., Osaka (JP)

(21) Appl. No.: 16/090,881

(22) PCT Filed: Apr. 3, 2017
(86) PCT No.: PCT/JP2017/013960

§ 371 Date: Oct. 3, 2018

(30) Foreign Application Priority Data
Apr. 13, 2016 (JP) 2016-079977

(51) Int. Cl. A23D 9/013; A23D 9/04; A23G 1/36; C11C 3/10

(52) U.S. Cl. CPC A23D 9/013; A23D 9/04; A23V 2002/00; C11C 3/10; A23G 1/36

(57) ABSTRACT

The present invention addresses the problem of providing an oil or fat for non-tempering chocolates, which enables the blending of cocoa butter at a high concentration in a lauric non-tempering chocolate, has heat resistance at such a level that the oil or fat can withstand the distribution at ambient temperature, has good gloss, luster, feeling upon eating, flavor and the like, and does not undergo the occurrence of blooming or change in hardness over time. An oil or fat containing an USU-type triglyceride is added at a proper content to a lauric hard butter. In this manner, the blending of cocoa butter at a high concentration into a chocolate prepared using a lauric hard butter, which is never before possible, becomes possible.

### TECHNICAL FIELD

The present invention relates to a fat composition for chocolate and a chocolate using the same.

### BACKGROUND ART

A fat used in a production of chocolates (hard butter in a broad sense, including cocoa butter) is classified into a tempering type and a non-tempering type, depending on a necessity of tempering in the production of chocolate. The tempering type hard butter contains 1,3-disaturated-2-unsaturated triglyceride as the major triglyceride composition similar to cocoa butter. The tempering type triglyceride has sharp and good melting speed in the mouth, and may replace cocoa butter in any proportion. However, because of the crystal polymorphism of the tempering type triglyceride, a tempering process is required and the conditions of use are restricted.

The non-tempering type hard butter is classified into a trans fatty acid type and a lauric type. The trans fatty acid hard butter contains trans fatty acid obtained by isomeric hydrogenation of liquid fat in the presence of a catalyst such as hydrogenating catalyst, sulfur-containing compound, and poisoning catalyst. The trans fatty acid hard butter shows inferior sharpness of melting speed in the mouth and taste than the tempering type hard butter.

Recently, findings of many nutritional and physiological properties of various fatty acids have been revealed. For example, research result that condition increasing the risk of becoming heart disease such as arteriosclerosis is caused by ingesting a fat containing high amount of trans fatty acids in excess is obtained. Therefore, a hard butter that has decreased amount of the trans fatty acid or does not substantially contain the trans fatty acid is demanded.

The lauric hard butter has sharp and good melting speed in the mouth similar to the tempering type. The lauric hard butter is inexpensive and shows good de-molding property and sufficiently high solidification speed. Thus, the lauric hard butter is widely used for, such as molded chocolate and coating chocolate for confectionery or bread.

However, the lauric hard butter shows extremely low compatibility to cocoa butter due to big structural difference between constituent triacylgricerol of the lauric hard butter and triacylgricerol contained in cocoa butter. Thus, when high amount of a material containing high amount of cocoa butter, such as cacao mass and cocoa butter, is added to a lauric non-tempering chocolate and the obtained chocolate is stored over a long period, it is known that the appearance of the chocolate may be impaired by blooming, and that the texture may be coarse by graining. This is because only symmetric triacylglycerol in cocoa butter is aggregated during long-term storage, and then further polymorph transformation proceeds. Therefore, the lauric non-tempering chocolate cannot contain high amount of cacao mass or cocoa butter, and thus it has a defect that the taste is inferior. However, from the recent improvements in consumer preference, a lauric non-tempering chocolate containing higher amount of cocoa butter having good taste, while maintaining various advantages of the lauric non-tempering chocolate, is demanded in the market.

In order to solve the above mentioned problem, i.e. high amount of cocoa butter cannot be added, Patent Document 1 discloses a chocolate containing a fat containing 90% by mass or more of saturated fatty acid having 16 or more carbon atoms, and 0.01 to 2% by mass of one or more of emulsifiers selected from the group consisting of polyglycerol fatty acid ester, sorbitan fatty acid ester, and sucrose fatty acid ester. Patent Document 1 describes that the obtained chocolate enables to suppress a generation of bloom from 3 days to 7 days. However, this period is insufficient for storage. A solution for storage for longer period has not been presented.

In addition to the above described solutions, Patent Document 2 discloses an anti-blooming agent obtained by adding two kinds of monoglyceride fatty acid ester to a lauric non-tempering chocolate at a specific ratio. Patent Document 2 discloses a solution of obtaining a lauric non-tempering chocolate which may be stored for 3 months or more. However, Patent Document 2 only discloses very low content of cocoa butter, 5% by weight or less in the chocolate, and thus the chocolate shows insufficient taste.

### PRIOR ART DOCUMENTS

### Patent Documents

Patent Document 1: JP 2014-103875 A

Patent Document 2: JP H07-247496 A

### SUMMARY OF INVENTION

### Problems to be Solved by Invention

As described above, a fat for lauric non-tempering chocolate, which enables to provide a lauric non-tempering chocolate which is hard to cause occurring blooming and graining after long storage despite high cocoa butter content, and which has good gloss, glaze, de-molding property, and texture, is demanded.

### Means for Solving Problems

The present inventors have intensively studied, and as a result, they have found that the above problems may be solved by adding a specific triacylglycerol species to a lauric hard butter at appropriate proportions. That is, a fat for chocolate which enables to provide a lauric non-tempering chocolate meeting the followings: high amount of cocoa butter may be added to the chocolate without tempering process; solidification speed of the chocolate in the step of molding with cooling is sufficiently high; heat resistance sufficient for room temperature distribution may be imparted to the chocolate; gloss, glaze, texture, melting speed in the mouth, and taste of the chocolate is good; and an occurrence of blooming and graining after a long storage may be suppressed, is developed to complete the present invention. More surprisingly, a problem of cracking and peeling often occurred in a lauric non-tempering chocolate coating on confectionery or bread is solved by the present invention. Thus, the present invention enables to solve many problems of the conventional lauric hard butter.

That is, the first aspect of the present invention is a fat composition containing a fat A and a fat B, where total content of the fat A and the fat B in the fat composition is 50% by weight or more, and a ratio of fat A to fat B (fat A/fat B) is 0.5 to 23, and where the fat A contains 35% or more of saturated fatty acid having 14 or less carbon atoms in the constituent fatty acids, and 80% or more of SFC at 10° C., 55% or more of SFC at 20° C., and 12% or less of SFC at 40° C., and where fat B contains 10 to 100% by weight of USU triacylglycerol in which saturated fatty acid having 16 to 22 carbon atoms (S) is bound to 2-position of glycerin and unsaturated fatty acids having 18 carbon atoms (U) are bound to 1,3-positions of glycerin.

The second aspect of the present invention is the fat composition of the first aspect, where the fat B contains 5% by weight or more of diglyceride.

The third aspect of the present invention is a method for producing a fat composition of the first aspect or the second aspect, where the fat B is obtained by subjecting a fat to interesterification step and/or fractionation step.

The fourth aspect of the present invention is a chocolate containing the fat composition of the first aspect, where a ratio of SUS triacylglycerol to USU triacylglycerol (SUS/USU) is 0.6 to 5.0, and where SUS triacylglycerol is a triacylglycerol in which saturated fatty acids having 16 to 22 carbon atoms (S) are bound to 1,3-positions of glycerin and unsaturated fatty acid having 18 carbon atoms (U) is bound to 2-position of glycerin.

The fifth aspect of the present invention is the chocolate of the fourth aspect, further containing 4 to 40% by weight of cocoa butter in the fat of chocolate.

### Effect of Invention

The present invention enables to increase an adding amount of cacao mass in chocolate raw materials in a non-tempering chocolate produced by using a lauric hard butter, by greatly improving a compatibility with a cocoa butter, which is a problem of lauric hard butter, while maintaining advantages of lauric hard butter, such as inexpensive, high solidification speed, good de-molding property, and sharp melting speed in the mouth. Thus, the present invention enables to provide a lauric non-tempering chocolate having greatly improved taste, showing less change in appearance and maintaining physical property by suppressing an occurrence of blooming and graining. Further, the present invention enables to suppress cracking and peeling of a lauric non-tempering chocolate coating on confectionery or bread.

### MODE FOR CARRYING OUT INVENTION

The present invention will be described in detail.

A fat composition of the present invention is obtained by mixing a fat A, which is lauric hard butter, and a fat B containing USU triacylglycerol.

A content of saturated fatty acid having 14 or less carbon atoms in the fat A is essential 35% by weight or more, preferably 45% by weight or more, more preferably 55% by weight or more, and further preferably 65% by weight or more. When the content is less than 35% by weight, sufficient solidification speed and de-molding property are not obtained, and thus, it is not preferable. SFC at 10° C. of the fat A is essential 80% or more, preferably 85% or more, more preferably 90% or more, further preferably 95% or more, and most preferably 98%. When the SFC is less than 80%, sufficient hardness, snappiness, and de-molding property are not obtained, and thus, it is not preferable. In addition, SFC at 20° C. of the fat A is essential 55% or more, preferably 60% or more, more preferably 80% or more, further preferably 90% or more, and most preferably 96% or more. When the SFC is less than 55%, sufficient hardness, snappiness, and de-molding property are not obtained, and thus, it is not preferable. SFC at 40° C. of the fat A is essential 12% or less, preferably 10% or less, more preferably 5% or less, further preferably 3% or less, and preferably 1% or more. When the SFC is more than 12%, melting speed in the mouth of the chocolate is deteriorated, that is, so-called waxy texture is generated, and thus, it is not preferable.

A content of USU triacylglycerol in the fat B is essential 10% by weight or more, preferably 15% by weight, more preferably 30% by weight or more, further preferably 60% by weight or more, and most preferably 80% by weight or more. In addition, it is preferably 95% or less, and more preferably 90% or less. When it is less than 10% by weight, blooming and graining are not sufficiently suppressed, and thus, it is not preferable. In addition, a content of diglyceride in the fat B is preferably 5% or more, more preferably 8% or more, further preferably 10% or more, and most preferably 14% or more. When diglyceride is less than 5 wt %, the effect of suppressing blooming and graining may not be sufficient.

A total amount of the fat A and the fat B contained in the fat composition of the present invention is essential 50% by weight or more, preferably 60% by weight or more, more preferably 70% by weight or more, and preferably 90% by weight or less, and further preferably 80% by weight or less. When it is less than 50% by weight, hardness, de-molding property, and solidification speed are not sufficient, and thus, it is not preferable. In addition, a ratio of fat A to fat B (fat A/fat B) is essential 0.5 to 23, preferably 1 to 6, more preferably 2 to 5, further preferably 2.5 to 4. When the ratio is less than 0.5, solidification speed, hardness, and de-molding property is not sufficient, and thus, it is not preferable.

Examples of the fat A, which is a lauric hard butter, include a single or mixed oil of vegetable fat such as palm kernel oil and coconut oil, processed fat thereof (including one or more processing steps selected from hydrogenation, fractionation, and interesterification), and a fat obtained by mixing other animal fat or vegetable fat to palm kernel oil or coconut oil, and processing. Among them, in particular, an interesterified fat obtained by mixing hard fraction of palm kernel oil and fully hydrogenated fat thereof, partially hydrogenated palm kernel oil, or processed fat of palm kernel oil or coconut oil, and other vegetable fat or animal fat, and then subjecting the mixture to interesterification may be preferably used.

Examples of the fat B, containing USU, include lard, single or mixed oil of one or more vegetable fat or animal fat, such as soybean oil, rapeseed oil, sunflower seed oil, cottonseed oil, peanut oil, rice bran oil, corn oil, safflower oil, olive oil, kapok oil, sesame oil, evening primrose oil, palm oil, shea butter, sal fat, illipe butter, milk fat, beef tallow, and lard, processed fat thereof (including one or more processing steps selected from hydrogenation, fractionation, and interesterification). Among them, in particular, a fat obtained through an interesterification, such as chemical method and enzyme method, and/or fractionation step may be preferably used.

The fat composition for chocolate of the present invention may contain a fat other than the fat A and the fat B as long as it does not inhibit the effect of the present invention. For example, it is preferable to add a fat having 45° C. or more of melting point in the point of improving a solidification speed of chocolate. Examples of the fat having 45° C. or more of melting point includes fully hydrogenated high-erucic rapeseed oil, fully hydrogenated palm oil, and fully hydrogenated rapeseed oil. A content of the fat having 45° C. or more of melting point is not particularly limited, but is usually less than 10% by weight, preferably less than 5% by weight, and more preferably less than 3% by weight as a total amount with respect to total weight of the fat composition.

A chocolate obtained by adding the fat composition of the present invention is hard to cause problems of blooming or graining even when high amount of cocoa butter is added. The present inventors make the assumption that these problems of blooming and graining are caused by aggregating only symmetric triacylglycerol in cocoa butter during long-term storage, and then proceeding further polymorph transformation, and that USU contained in the fat composition of the present invention suppress them.

Therefore, USU content to SUS content in the chocolate is important, and the ratio of USU to SUS in the fat (USU/SUS) is required to be 0.6 to 5.0. And, the ratio is preferably 0.9 or more, more preferably 1.0 or more, and preferably 1.5 or less, and more preferably 1.2 or less. When the ratio of USU content to SUS content is less than 0.6, blooming and graining cannot be sufficiently suppressed, and when the ratio is more than 5.0, solidification speed, de-molding property, and heat resistance and shape retention property are insufficient. Thus, it is not preferable.

The chocolate of the present invention preferably contains 4 to 40% of cocoa butter in the chocolate fat. It is more preferably 8% or more, further preferably 15% or more, and most preferably 20% or more. And, it is more preferably 35% or less, further preferably 30% or less, and most preferably 25% or less. When cocoa butter content in the chocolate fat is less than 4%, chocolate having good chocolate flavor is relatively hard to be obtained.

An origin of SUS contained in the chocolate of the present invention may be a fat other than cocoa butter. Specific examples of SUS-containing fat include vegetable fat such as palm oil, rhea butter, sal fat, illipe butter, and cocoa butter, and fractionated oil thereof, and an enzymatic interesterified oil prepared by using various animal and vegetable fat, and fatty acid and/or lower alcohol ester of fatty acid, and fractionated oil thereof. It is preferable to contain palm mid fraction in SUS-containing fat in the point of melting speed in the mouth of the chocolate. In this case a content of palm mid fraction fat is not particularly limited, but is usually less than 30% by weight, preferably less than 20% by weight, further preferably less than 10% by weight, and most preferably less than 5% by weight, as the total amount in the fat composition of the present invention.

As used herein, “chocolate” may not be limited by rules (“Fair Competition Convention on the Show Kind of Chocolate”) and ordinances, and includes various kinds of chocolates, for example, sweet chocolate, milk chocolate, semi-sweet chocolate, semi-milk chocolate, white chocolate or color chocolate such as strawberry, filling chocolate, and various kind of fat processed food.

### EXAMPLES

Examples will be described in the following. However, the spirit of the present invention is not limited by the examples. In the examples, both of % and part mean a weight basis unless otherwise stated.

### (Preparation of Lauric Fat A)

Fat Aa: fully hydrogenated fat of high melting point fraction of palm kernel oil (content of saturated fatty acid having 14 or less carbon atoms: 81%, SFC at 10° C.: 97%, SFC at 20° C.: 96%, SFC at 40° C.: 0%)

Fat Ab: partially hydrogenated fat of palm kernel oil (content of saturated fatty acid having 14 carbon atoms or less carbon atoms: 69%, SFC at 10° C.: 95%, SFC at 20° C.: 84%, SFC at 40° C.: 1%)

Fat Ac: fully hydrogenated fat of interesterified fat of 85 parts of palm kernel oil, 5 parts of palm oil and 10 parts of fully hydrogenated high-erucic rapeseed oil (content of saturated fatty acid having 14 carbon atoms or less carbon atoms: 59%, SFC at 10° C.: 96%, SFC at 20° C.: 86%, SFC at 40° C.: 5%)

Fat Ad: interesterified fat of 50 parts of coconuts oil, 40 parts of palm stearin and 10 parts of fully hydrogenated high-elucic rapeseed oil (content of saturated fatty acid having 14 carbon atoms or less carbon atoms: 38%, SFC at 10° C.: 83%, SFC at 20° C.: 58%, SFC at 40° C.: 4%)

Fat Ae: mixed fat of 70 parts of fat Ac and 30 parts of interesterified fat of 10 parts of palm stearin, 50 parts of palm oil and 40 parts of low melting point fraction of palm kernel oil (content of saturated fatty acid having 14 carbon atoms or less carbon atoms: 48%, SFC at 10° C.: 91%, SFC at 20° C.: 69%, SFC at 40° C.: 0%)

Fat Af: mixed fat of 37.5 parts of fat Aa and 62.5 parts of fat Ad (content of saturated fatty acid having 14 carbon atoms or less carbon atoms: 54%, SFC at 10° C.: 88%, SFC at 20° C.: 72%, SFC at 40° C.: 7%)

### (Preparation of USU-Containing Fat Ba)

Mixed fat was prepared by mixing 30 parts of fully hydrogenated rapeseed oil and 70 parts of ethyl oleate, and then bleaching the mixture by known method. The mixed fat was subjected to an interesterification with commercially available 1,3-position specific lipase. An interesterified fat was obtained by subjecting the interesterification reaction product to a known distillation method to remove fatty acid ethyl ester. The obtained fat was fractionated with a known method to remove the high melting point fraction, and then refined to obtain fat Ba containing 81% by weight of USU and 7.0% of diglyceride.

### (Preparation of USU-Containing Fat Bb)

Palm oil, palm stearin and fully hydrogenated palm oil are subjected to an interesterification with a known method. The interesterified fat was fractionated with a known method to remove the high melting point fraction and mid melting point fraction, and then refined to obtain fat Bb containing 17% by weight of USU and 17.0% of diglyceride.

### Preparation 1, Preparation of Fat Compositions of Examples and Comparative Examples

A fat composition of Example 1 was obtained by mixing 11.2 parts of fat Ba and 88.8 parts of fat Aa (fat A/fat B=7.9).

A fat composition of Example 2 was obtained by mixing 17.7 parts of fat Ba and 82.3 parts of fat Aa (fat A/fat B=4.6).

A fat composition of Example 3 was obtained by mixing 24.9 parts of fat Ba and 75.1 parts of fat Aa (fat A/fat B=3.0).

A fat composition of Example 4 was obtained by mixing 32.8 parts of fat Ba and 67.2 parts of fat Aa (fat A/fat B=2.1).

Fat Aa alone was used as a fat composition of Comparative Examples 1 and 2.

A fat composition of Comparative Example 3 was obtained by mixing 69.9 parts of fat Ba and 30.1 parts of fat Aa (fat A/fat B=0.43).

A fat composition of Comparative Example 4 was obtained by mixing 5.5 parts of fat Ba and 95.5 parts of fat Aa (fat A/fat B=17.2).

A fat composition of Comparative Example 5 was obtained by mixing 30.6 parts of fat Ba and 69.4 parts of fat Aa (fat A/fat B=2.3).

A fat composition of Comparative Example 6 was obtained by mixing 3.8 parts of fat Ba and 96.2 parts of fat Aa (fat A/fat B=25.4).

Based on the formulations shown in Table 1, chocolate doughs were prepared by using the above fat compositions. In addition, the fat compositions of the chocolates are shown in Table 2.

TABLE 1
Formulations of chocolates (part by weight)

| | Examples | | | | Comparative Examples | | | | | |
|---|---|---|---|---|---|---|---|---|---|---|
| | 1A | 2A | 3A | 4A | 1A | 2A | 3A | 4A | 5A | 6A |
| Cacao mass | 3.7 | 7.6 | 11.4 | 15.1 | 3.7 | 15.3 | 28.0 | 15.1 | 7.6 | 0.0 |
| Cocoa powder | 16.7 | 14.7 | 12.8 | 10.9 | 16.7 | 10.8 | 4.3 | 10.9 | 14.7 | 12.8 |
| Sugar | 45.0 | 45.0 | 45.0 | 45.0 | 45.0 | 45.0 | 45.0 | 45.0 | 45.0 | 50.0 |
| Lecithin | 0.2 | 0.2 | 0.2 | 0.2 | 0.2 | 0.2 | 0.2 | 0.2 | 0.2 | 0.2 |
| Fat composition | 34.6 | 0.0 | 0.0 | 0.0 | 0.0 | 0.0 | 0.0 | 0.0 | 0.0 | 0.0 |
| of Example 1 | | | | | | | | | | |
| Fat composition | 0.0 | 32.7 | 0.0 | 0.0 | 0.0 | 0.0 | 0.0 | 0.0 | 0.0 | 0.0 |
| of Example 2 | | | | | | | | | | |
| Fat composition | 0.0 | 0.0 | 30.8 | 0.0 | 0.0 | 0.0 | 0.0 | 0.0 | 0.0 | 0.0 |
| of Example 3 | | | | | | | | | | |
| Fat composition | 0.0 | 0.0 | 0.0 | 29.0 | 0.0 | 0.0 | 0.0 | 0.0 | 0.0 | 0.0 |
| of Example 4 | | | | | | | | | | |
| Fat composition | 0.0 | 0.0 | 0.0 | 0.0 | 34.6 | 0.0 | 0.0 | 0.0 | 0.0 | 0.0 |
| of Comparative | | | | | | | | | | |
| Example 1 | | | | | | | | | | |
| Fat composition | 0.0 | 0.0 | 0.0 | 0.0 | 0.0 | 28.9 | 0.0 | 0.0 | 0.0 | 0.0 |
| of Comparative | | | | | | | | | | |
| Example 2 | | | | | | | | | | |
| Fat composition | 0.0 | 0.0 | 0.0 | 0.0 | 0.0 | 0.0 | 22.7 | 0.0 | 0.0 | 0.0 |
| of Comparative | | | | | | | | | | |
| Example 3 | | | | | | | | | | |
| Fat composition | 0.0 | 0.0 | 0.0 | 0.0 | 0.0 | 0.0 | 0.0 | 32.7 | 0.0 | 0.0 |
| of Comparative | | | | | | | | | | |
| Example 4 | | | | | | | | | | |
| Fat composition | 0.0 | 0.0 | 0.0 | 0.0 | 0.0 | 0.0 | 0.0 | 0.0 | 32.7 | 0.0 |
| of Comparative | | | | | | | | | | |
| Example 5 | | | | | | | | | | |
| Fat composition | 0.0 | 0.0 | 0.0 | 0.0 | 0.0 | 0.0 | 0.0 | 0.0 | 0.0 | 37.2 |
| of Comparative | | | | | | | | | | |
| Example 6 | | | | | | | | | | |

TABLE 2
Fat compositions in chocolates

| | | Examples | | | | Comparative Examples | | | | | |
|---|---|---|---|---|---|---|---|---|---|---|---|
| | | 1A | 2A | 3A | 4A | 1A | 2A | 3A | 4A | 5A | 6A |
| Amount in | Fat A | 79.9 | 69.9 | 60.1 | 50.6 | 89.9 | 75.1 | 17.7 | 80.3 | 59.0 | 92.7 |
| chocolate | Fat B | 10.1 | 15.1 | 20.0 | 24.7 | 0.0 | 0.0 | 41.2 | 4.7 | 26.0 | 3.6 |
| fat (wt %) | Cocoa butter | 10.1 | 15.1 | 20.0 | 24.7 | 10.1 | 24.9 | 41.2 | 15.1 | 15.1 | 3.6 |
| Content in | SUS | 8.6 | 12.8 | 17.0 | 21.0 | 8.6 | 21.2 | 35.0 | 12.8 | 12.8 | 3.1 |
| chocolate | USU | 8.6 | 12.8 | 17.0 | 21.0 | 0.0 | 0.0 | 35.0 | 4.0 | 22.1 | 3.1 |
| fat (wt %) | | | | | | | | | | | |
| | SUS/USU ratio | 1.0 | 1.0 | 1.0 | 1.0 | ∞ | ∞ | 1.0 | 3.2 | 0.6 | 1.0 |

Chocolate dough prepared by the above ratio was heated to 60° C. of the product temperature. The heated dough was stirred sufficiently, and then poured into a mold at a product temperature of 45° C. The molded dough was cooled to solidify at 15° C. for 30 minutes without a tempering treatment, and then de-molded. The samples were stored at 15° C. constant, 20° C. constant, 25° C. constant, or cycle conditions 15-25° C./day for 6 months. The results of the surface observation are shown in Table 3. In addition, the results of eating evaluation of the chocolate stored at 25° C. after 1 week stabilization at 20° C. are shown in Table 4.

TABLE 3
Results of surface observation (6 months)

| | Storage temperature | | | |
|---|---|---|---|---|
| | 15° C. | 20° C. | 25° C. | 15° C.-25° C. cycle |
| Example 1A | − | − | − | − |
| Example 2A | − | − | − | − |
| Example 3A | − | − | − | − |
| Example 4A | − | − | − | − |
| Comparative | ++ | ++ | + | + |
| Example 1A | | | | |
| Comparative | ++ | +++ | ++ | + |
| Example 2A | | | | |
| Comparative | − | − | − | − |
| Example 3A | | | | |
| Comparative | +++ | +++ | ++ | + |
| Example 4A | | | | |
| Comparative | − | − | − | − |
| Example 5A | | | | |
| Comparative | − | − | − | − |
| Example 6A | | | | |

Criteria: −: gloss was sufficient, −+: gloss was slightly lost, +: gloss was lost, and blooming was slightly occurred, ++: blooming was occurred, and product value was lost, +++ or more: blooming was occurred on the whole surface. Product maintaining the evaluation of “−” in all of the storage conditions after 6 months storage was deemed sufficient.

TABLE 4
Results of eating evaluation

| | Eating evaluation |
|---|---|
| Example 1A | Very good snappiness, good melting speed in the |
| | mouth, enough strong taste |
| Example 2A | Enough good snappiness, good melting speed in |
| | the mouth, strong taste |
| Example 3A | Enough good snappiness, good melting speed in |
| | the mouth, strong taste |
| Example 4A | Good snappiness, good melting speed in the |
| | mouth, very strong taste |
| Comparative | Good snappiness, poor melting speed in the |
| Example 1A | mouth, poor taste expression |
| Comparative | Good snappiness, considerably poor melting |
| Example 2A | speed in the mouth, considerably poor taste |
| | expression |
| Comparative | No snappiness, good melting speed in the mouth, |
| Example 3A | very strong taste |
| Comparative | Good snappiness, poor melting speed in the |
| Example 4A | mouth, poor taste expression |
| Comparative | No snappiness, good melting speed in the mouth, |
| Example 5A | very strong taste |
| Comparative | Enough good snappiness, good melting speed in |
| Example 6A | the mouth, weak taste |

Examples 1A to 4A maintained good surface condition during 6 months at any storage temperature conditions. In addition, these Examples showed good snappiness and melting speed in the mouth, and sufficiently strong chocolate taste. However, occurrence of bloom was observed in Comparative Examples 1A, 2A and 4A. In addition, these Comparative Examples showed poor melting speed in the mouth and taste expression. Comparative Examples 3A and 5A showed good surface condition, but poor snappiness. Comparative Example 6A showed good surface condition, and good snappiness and melting speed in the mouth, but there is a problem that the taste was weak due to no addition of cacao mass.

### Preparation 2, Preparation of Fat Compositions of Examples and Comparative Examples

A fat composition of Example 5 was obtained by mixing 22.7 parts of fat Bb and 77.3 parts of fat Aa (fat A/fat B=3.4).

A fat composition of Example 6 was obtained by mixing 22.7 parts of fat Bb and 77.3 parts of fat Ab (fat A/fat B=3.4).

A fat composition of Example 7 was obtained by mixing 22.7 parts of fat Bb and 77.3 parts of fat Ac (fat A/fat B=3.4).

A fat composition of Example 8 was obtained by mixing 22.7 parts of fat Bb and 77.3 parts of fat Ad (fat A/fat B=3.4).

A fat composition of Example 9 was obtained by mixing 22.7 parts of fat Bb and 77.3 parts of fat Ae (fat A/fat B=3.4).

A fat composition of Example 10 was obtained by mixing 45.3 parts of fat Bb and 54.7 parts of fat Aa (fat A/fat B=1.2).

A fat composition of Example 11 was obtained by mixing 45.3 parts of fat Bb and 54.7 parts of fat Ab (fat A/fat B=1.2).

A fat composition of Example 12 was obtained by mixing 45.3 parts of fat Bb and 54.7 parts of fat Ac (fat A/fat B=1.2).

A fat composition of Example 13 was obtained by mixing 45.3 parts of fat Bb and 54.7 parts of fat Ad (fat A/fat B=1.2).

A fat composition of Example 14 was obtained by mixing 45.3 parts of fat Bb and 54.7 parts of fat Ae (fat A/fat B=1.2).

Fat Aa alone was used as a fat composition of Comparative Example 7.

Fat Ab alone was used as a fat composition of Comparative Example 8.

Fat Ac alone was used as a fat composition of Comparative Example 9.

Fat Ad alone was used as a fat composition of Comparative Example 10.

Fat Ae alone was used as a fat composition of Comparative Example 11.

Based on the formulations shown in Table 5, chocolate doughs of Examples 5A to 14A and Comparative Examples 7A to 11A were prepared by using the above fat compositions of Examples 5 to 14 and Comparative Examples 7 to 11. In addition, the fat compositions of the chocolates are shown in Tables 6 and 7.

TABLE 5
Formulation of chocolate (part by weight)

| | Chocolate dough |
|---|---|
| Cacao mass | 10.0 |
| Cocoa powder | 11.2 |
| Whole fat milk powder | 8.4 |
| Sugar | 34.4 |
| Fat composition of Examples or | 36.0 |
| Comparative Examples | |
| Lecithin | 0.2 |

TABLE 6
Fat compositions in chocolates

| | | Examples | | | | | | | | | |
|---|---|---|---|---|---|---|---|---|---|---|---|
| | | 5A | 6A | 7A | 8A | 9A | 10A | 11A | 12A | 13A | 14A |
| Amount in | Fat A | 62.0 | 62.0 | 62.0 | 62.0 | 62.0 | 43.8 | 43.8 | 43.8 | 43.8 | 43.8 |
| chocolate | Fat B | 18.2 | 18.2 | 18.2 | 18.2 | 18.2 | 36.3 | 36.3 | 36.3 | 36.3 | 36.3 |
| fat (wt %) | Cocoa butter | 15.0 | 15.0 | 15.0 | 15.0 | 15.0 | 15.0 | 15.0 | 15.0 | 15.0 | 15.0 |
| | Milk fat | 4.9 | 4.9 | 4.9 | 4.9 | 4.9 | 4.9 | 4.9 | 4.9 | 4.9 | 4.9 |
| Content in | SUS | 14.1 | 14.1 | 14.1 | 15.7 | 15.0 | 15.4 | 15.4 | 15.4 | 16.5 | 16.0 |
| chocolate | USU | 3.0 | 3.0 | 3.0 | 3.6 | 3.8 | 6.0 | 6.0 | 6.0 | 6.4 | 6.6 |
| fat (wt %) | | | | | | | | | | | |
| | SUS/USU ratio | 4.7 | 4.7 | 4.7 | 4.4 | 3.9 | 2.6 | 2.6 | 2.6 | 2.6 | 2.4 |

TABLE 7
Fat compositions in chocolates

| | | Comparative Examples | | | | |
|---|---|---|---|---|---|---|
| | | 7A | 8A | 9A | 10A | 11A |
| Amount in | Fat A | 80.1 | 80.1 | 80.1 | 80.1 | 80.1 |
| chocolate | Fat B | 0.0 | 0.0 | 0.0 | 0.0 | 0.0 |
| fat (wt %) | Cocoa butter | 15.0 | 15.0 | 15.0 | 15.0 | 15.0 |
| | Milk fat | 4.9 | 4.9 | 4.9 | 4.9 | 4.9 |
| Content in | SUS | 12.7 | 12.7 | 12.7 | 14.8 | 13.9 |
| chocolate | USU | 0.0 | 0.0 | 0.0 | 0.8 | 1.1 |
| fat (wt %) | | | | | | |
| | SUS/USU ratio | ∞ | ∞ | ∞ | 19.6 | 12.5 |

Chocolate dough prepared by the above ratio was heated to 60° C. of the product temperature. The heated dough was stirred sufficiently, and then poured into a plastic cup at a product temperature of 45° C. The molded dough was cooled to solidify at 5° C. without a tempering treatment. The samples were stored at 20° C. constant for 4 months, 25° C. constant for 2 months. The results of the surface observation are shown in Table 8.

TABLE 8
Results of surface observation

Storage temperature

| | 20° C. | 25° C. |
|---|---|---|
| Storage period | 4 months | 2 months |
| Example 5A | −+ | −+ |
| Example 6A | − | −+ |
| Example 7A | −+ | −+ |
| Example 8A | − | − |
| Example 9A | −+ | − |
| Example 10A | −+ | − |
| Example 11A | − | − |
| Example 12A | − | − |
| Example 13A | − | − |
| Example 14A | − | − |
| Comparative | +++ | +++ |
| Example 7A | | |
| Comparative | ++ | ++ |
| Example 8A | | |
| Comparative | ++ | +++ |
| Example 9A | | |
| Comparative | + | + |
| Example 10A | | |
| Comparative | ++ | ++ |
| Example 11A | | |

Criteria: −: gloss was sufficient, −+: gloss was slightly lost, +: gloss was lost, and blooming was slightly occurred, ++: blooming was occurred, and product value was lost, +++ or more: blooming was occurred on the whole surface.

Product maintaining the evaluation of “−” or “−+” after 4 months storage at 20° C. or after 2 months storage at 25° C. was deemed sufficient.

Surface observation results of Examples 5A to 14A were sufficient. However, Comparative Examples 7A to 11A were unacceptable.

### Preparation 3, Preparation of Fat Compositions of Examples and Comparative Examples

A fat composition of Example 15 was obtained by mixing 29.2 parts of fat Ba and 50.4 parts of fat Af, 12 parts of cocoa butter, 6.3 parts of palm low melting point fraction (iodine value: 67) and 2.1 parts of partially hydrogenated palm low melting point fraction (iodine value: 35) (fat A/fat B=1.7).

A fat composition of Example 16 was obtained by mixing 26.2 parts of fat Ba and 55.6 parts of fat Af, 9 parts of cocoa butter, 6.9 parts of palm low melting point fraction (iodine value: 67) and 2.3 parts of partially hydrogenated palm low melting point fraction (iodine value: 35) (fat A/fat B=2.1).

A fat composition of Example 17 was obtained by mixing 23.2 parts of fat Ba and 60.7 parts of fat Af, 6 parts of cocoa butter, 7.6 parts of palm low melting point fraction (iodine value: 67) and 2.5 parts of partially hydrogenated palm low melting point fraction (iodine value: 35) (fat A/fat B=2.6).

A fat composition of Example 18 was obtained by mixing 17.2 parts of fat Ba and 70.9 parts of fat Af, 8.4 parts of palm low melting point fraction (iodine value: 67) and 3.0 parts of partially hydrogenated palm low melting point fraction (iodine value: 35) (fat A/fat B=4.1).

A fat composition of Comparative Example 12 was obtained by mixing 75.4 parts of fat Af, 12 parts of cocoa butter, 9.4 parts of palm low melting point fraction (iodine value: 67) and 3.2 parts of partially hydrogenated palm low melting point fraction (iodine value: 35).

A fat composition of Comparative Example 13 was obtained by mixing 78.0 parts of fat Af, 9 parts of cocoa butter, 9.7 parts of palm low melting point fraction (iodine value: 67) and 3.3 parts of partially hydrogenated palm low melting point fraction (iodine value: 35).

A fat composition of Comparative Example 14 was obtained by mixing 80.6 parts of fat Af, 6 parts of cocoa butter, 10.1 parts of palm low melting point fraction (iodine value: 67) and 3.4 parts of partially hydrogenated palm low melting point fraction (iodine value: 35).

A fat composition of Comparative Example 15 was obtained by mixing 85.7 parts of fat Af, 10.7 parts of palm low melting point fraction (iodine value: 67) and 3.6 parts of partially hydrogenated palm low melting point fraction (iodine value: 35).

Based on the formulations shown in Table 9, chocolate doughs of Examples 15A to 18A and Comparative Examples 12A to 15A were prepared by using the above fat compositions of Examples 15 to 18 and Comparative Examples 12 to 15. In addition, the fat compositions of the chocolates are shown in Table 10.

TABLE 9
Formulation of chocolate (part by weight)

| | Chocolate dough |
|---|---|
| Cacao mass | 10.2 |
| Cocoa powder | 13.5 |
| Whole fat milk powder | 3.7 |
| Sugar | 31.6 |
| Fat composition of Examples or | 41.0 |
| Comparative Examples | |
| Lecithin | 0.2 |

TABLE 10
Fat compositions in chocolates

| | | Examples | | | | Comparative Examples | | | |
|---|---|---|---|---|---|---|---|---|---|
| | | 15A | 16A | 17A | 18A | 12A | 13A | 14A | 15A |
| Amount in | Fat A | 42.2 | 46.4 | 50.7 | 59.3 | 63.1 | 65.2 | 67.4 | 71.7 |
| chocolate | Fat B | 24.4 | 21.9 | 19.4 | 14.4 | 0.0 | 0.0 | 0.0 | 0.0 |
| fat (wt %) | Cocoa butter | 24.4 | 21.9 | 19.4 | 14.4 | 24.4 | 21.9 | 19.4 | 14.4 |
| | Milk fat | 2.0 | 2.0 | 2.0 | 2.0 | 2.0 | 2.0 | 2.0 | 2.0 |
| Content in | SUS | 22.7 | 20.7 | 18.8 | 14.9 | 23.6 | 21.6 | 19.5 | 15.5 |
| chocolate | USU | 21.0 | 19.0 | 16.9 | 12.7 | 0.4 | 0.5 | 0.5 | 0.5 |
| fat (wt %) | | | | | | | | | |
| | SUS/USU ratio | 1.1 | 1.1 | 1.1 | 1.1 | 53.0 | 46.8 | 41.1 | 30.6 |

Chocolate dough prepared by the above ratio was heated to 60° C. of the product temperature. The heated dough was stirred sufficiently, then cooled to 45° C., and then coated on bread roll with a coating weight of 3.1±0.5 g. The coated dough was cooled to solidify at 5° C. The samples were cut with a knife at 5° C. atmosphere, and cracking and peeling of chocolate were evaluated. The results of the evaluation are shown in Table 11.

TABLE 11
Results of evaluation of cracking and peeling

| | Result of evaluation |
|---|---|
| Example 15A | There was neither cracking nor peeling. It was |
| | most easily cut. |
| Example 16A | There was extremely low cracking and peeling. It |
| | was easily cut. |
| Example 17A | There was low cracking and peeling. It was |
| | easily cut. |
| Example 18A | There was low cracking and peeling. It was |
| | easily cut. |
| Comparative | There was heavy cracking and peeling. Many |
| Example 12A | pieces of chocolate fell down when it was cut. |
| Comparative | There was heavy cracking and peeling. Many |
| Example 13A | pieces of chocolate fell down when it was cut. |
| Comparative | There was extremely heavy cracking and peeling. |
| Example 14A | Many pieces of chocolate fell down when it was cut. |
| Comparative | There was most heavy cracking and peeling. Many |
| Example 15A | pieces of chocolate fell down when it was cut. |

Chocolates of Examples 15A to 18A showed less cracking and peeling, and were preferable. However, Comparative Examples 12A to 15A showed heavy cracking and peeling, and were poor.

### INDUSTRIAL APPLICABILITY

The present invention enables to provide a fat for lauric non-tempering chocolate, which enables to provide a lauric non-tempering chocolate which is hard to cause occurring blooming and graining after long storage despite high cocoa butter content, and has good gloss, glaze, de-molding property, and texture.

1. A fat composition comprising a fat A and a fat B, wherein total content of the fat A and the fat B in the fat composition is 50% by weight or more, and a ratio of fat A to fat B (fat A/fat B) is 0.5 to 23, and wherein the fat A comprises 35% or more of saturated fatty acid having 14 or less carbon atoms in the constituent fatty acids, and 80% or more of SFC at 10° C., 55% or more of SFC at 20° C., and 12% or less of SFC at 40° C., and wherein fat B comprises 10 to 100% by weight of USU triacylglycerol in which saturated fatty acid having 16 to 22 carbon atoms (S) is bound to 2-position of glycerin and unsaturated fatty acids having 18 carbon atoms (U) are bound to 1,3-positions of glycerin.

2. The fat composition according to claim 1, wherein the fat B comprises 5% by weight or more of diglyceride.

3. A method for producing a fat composition of claim 1, wherein the fat B is obtained by subjecting a fat to interesterification step and/or fractionation step.

4. A chocolate comprising the fat composition of claim 1, wherein a ratio of SUS triacylglycerol to USU triacylglycerol (SUS/USU) is 0.6 to 5.0, and wherein SUS triacylglycerol is a triacylglycerol in which saturated fatty acids having 16 to 22 carbon atoms (S) are bound to 1,3-positions of glycerin and unsaturated fatty acid having 18 carbon atoms (U) is bound to 2-position of glycerin.

5. The chocolate according to claim 4, further comprising 4 to 40% by weight of cocoa butter in the fat of chocolate.

6. A method for producing a fat composition of claim 2, wherein the fat B is obtained by subjecting a fat to interesterification step and/or fractionation step.
